(19) United States
(12) Patent Application Publication
(10) Pub. No.: US 2022/0179546 A1
(43) Pub. Date: Jun. 9, 2022

(54) DOCUMENT DISPLAY METHOD AND DEVICE

(71) Applicants: BEIJING KINGSOFT OFFICE SOFTWARE, INC., Beijing (CN); ZHUHAI KINGSOFT OFFICE SOFTWARE CO., LTD, Zhuhai, Guangdong (CN)

(72) Inventor: Jian ZHU, Zhuhai, Guangdong (CN)

(73) Assignees: BEIJING KINGSOFT OFFICE SOFTWARE, INC., Beijing (CN); ZHUHAI KINGSOFT OFFICE SOFTWARE CO., LTD, Zhuhai, Guangdong (CN)

(21) Appl. No.: 17/619,425

(22) PCT Filed: Aug. 24, 2020
(86) PCT No.: PCT/CN2020/110915

§ 371 Date: Dec. 15, 2021

(30) Foreign Application Priority Data
Aug. 23, 2019 (CN) 201910786505.8

(51) Int. Cl. G06F 3/04845; G06F 3/0481; G06F 1/16

(52) U.S. Cl. CPC G06F 3/04845; G06F 2203/04803; G06F 1/1652; G06F 3/0481

(57) ABSTRACT

A method and an apparatus for displaying a document, relate to the technical field of computers, and the method includes: displaying a target document on the flexible display screen; when a display mode of the flexible display screen is detected to be switched, deleting a first shell of the target document, and determining the target display state of the target document after the display mode of the flexible display screen is switched; and generating a second shell corresponding to the target display state, and displaying the target document after the display mode of the flexible display screen is switched on the flexible display screen through the second shell.

The present disclosure claims the priority to a Chinese patent application No. 201910786505.8, filed with the China National Intellectual Property Administration on Aug. 23, 2019 and entitled “document display method and apparatus,” which is incorporated herein by reference in its entirety.

### TECHNICAL FIELD

The present disclosure relates to the field of computer technology, and in particular to a method and an apparatus for displaying a document.

### BACKGROUND

WPS (Word Processing System) application is a common document processing software, and documents processed using the WPS application can be called WPS documents. A flexible screen mobile phone is a bendable and foldable mobile electronic device that may have two display states: a mobile phone state and a tablet state. The two display states are realized through folding or unfolding the mobile phone. When the two display states are switched to one other, the form of the WPS application will also be changed accordingly to ensure the user's reading experience for WPS documents.

When the WPS application is switched between the mobile phone state and the tablet state, current technologies require the electronic device to close the WPS documents and reopen them in the other display state.

### SUMMARY

The purpose of the embodiments of the present disclosure is to provide a method and an apparatus for displaying a document, so as to realize a user insensitive switching when switching the display states of the document, and reduce the possibility of losing content being processed prior to the switching, thereby ensuring the safety of the document content. The implemented technical solutions are as follows.

In a first aspect, the present disclosure provides a method for displaying a document, being applied to a terminal with a flexible display screen, including:

displaying a target document on the flexible display screen;

responsive to detecting a display mode of the flexible display screen being switched, deleting a first shell of the target document, and determining a target display state of the target document after the display mode of the flexible display screen is switched; and

generating a second shell corresponding to the target display state; and displaying the target document after the display mode of the flexible display screen is switched on the flexible display screen through the second shell.

Optionally, generating the second shell corresponding to the target display state includes:

determining the second shell corresponding to the target display state according to a preset correspondence between display modes and shells, where the second shell includes a second code and a second container; and

inputting the second code and the second container into a code sequence corresponding to the target document to generate the second shell corresponding to the target display state.

Optionally, deleting the first shell of the target document includes:

deleting the first shell of the target document, the first shell including a first code and a first container.

Optionally, determining the target display state of the target document after the display mode of the flexible display screen is switched includes:

determining a target display mode of the flexible display screen; and

determining the target display state corresponding to the target display mode according to a correspondence between the target display mode of the flexible display screen and the target display state of the target document.

In a second aspect, the present disclosure provides an apparatus for displaying a document, being applied to a terminal with a flexible display screen, including:

a display module configured to display a target document on the flexible display screen;

a deletion module configured to, responsive to detecting a display mode of the flexible display screen being switched, delete a first shell of the target document, and determine a target display state of the target document after the display mode of the flexible display screen is switched; and

a generating module configured to generate a second shell corresponding to the target display state, and display the target document after the display mode of the flexible display screen is switched on the flexible display screen through the second shell.

Optionally, the generating module is configured to:

determine the second shell corresponding to the target display state according to a preset correspondence between display modes and shells, where the second shell includes a second code and a second container; and

input the second code and the second container into a code sequence corresponding to the target document to generate the second shell corresponding to the target display state.

Optionally, the deletion module is configured to:

delete the first shell of the target document, the first shell including a first code and a first container.

Optionally, the deletion module is configured to:

determine a target display mode of the flexible display screen; and

determine the target display state corresponding to the target display mode according to a correspondence between the target display mode of the flexible display screen and the target display state of the target document.

In a third aspect, the present disclosure provides an electronic device, including a processor, a communication interface, a memory, and a communication bus, wherein the processor, the communication interface and the memory communicate with each other through the communication bus;

the memory is configured to store computer programs; and

the processor is configured to implement the method of the first aspect when executing the computer programs stored in the memory.

In a fourth aspect, the present disclosure provides a computer-readable storage medium, having computer programs stored thereon, when executed by a processor, cause the processor to perform operations of the first aspect.

In a fifth aspect, the present disclosure provides a computer program product containing instructions, when executed on a computer, causes the computer to perform operations of the first aspect.

In a sixth aspect, the present disclosure provides a computer program, when executed on a computer, causes the computer to execute operations of the first aspect.

The embodiments of the present disclosure provide a method and an apparatus for displaying a document, an electronic device can display a target document on a flexible display screen. Responsive to detecting the display mode of the flexible display screen being switched, the electronic device can delete a first shell of the target document, and determine the target display state of the target document after the display mode of the flexible display screen is switched. The electronic device can generate a second shell corresponding to the target display state, and display the target document after the display mode of the flexible display screen is switched on the flexible display screen through the second shell. In the embodiments of the present disclosure, the electronic device can switch merely the shell for the target document while retaining the editor and the document kernel of the target document. In this way, when the electronic device switches the display state, the display state of the document can be switched without closing the currently opened document and/or in-editing document. Clearly with the present solution, when switching the display state of the document, user insensitive switching is realized, and the possibility of losing content being processed before the switching is reduced, thus ensuring the safety of the document content.

Further, since there is no need to close the currently open document and/or in-editing document, the document is not required to be re-opened, thereby improving the efficiency during switching display states and improving the smoothness of document display, and improving the user experience.

Naturally, implementing any product or method of the present disclosure does not necessarily need to achieve all the advantages described above simultaneously.

### BRIEF DESCRIPTION OF THE DRAWINGS

In order to describe the technical solutions of the embodiments of the present disclosure more clearly, drawings that need to be used in embodiments will be briefly described below. Clearly, the drawings provided below are for only some embodiments of the present disclosure; those skilled in the art can also obtain other drawings based on these drawings without any creative efforts.

FIG. 1 is a flowchart of a method for displaying a document according to an embodiment of the present disclosure;

FIG. 2 is a schematic diagram of a display interface according to embodiments of the present disclosure;

FIG. 3 is a flowchart of a method for displaying a document according to an another embodiment of the present disclosure;

FIG. 4 is a schematic structural diagram of an apparatus for displaying a document according to an embodiment of the present disclosure; and

FIG. 5 is a schematic structural diagram of an electronic device according to an embodiment of the present disclosure.

### DETAILED DESCRIPTION

In order to make the objectives, technical solutions, and advantages of the present disclosure clearer and more understandable, the present disclosure will be described in more detail below with reference to the appended drawings and embodiments. Clearly, the described embodiments are only some, and not all, of the embodiments of the present disclosure. All other embodiments obtained based on the embodiments of the present disclosure by those skilled in the art without any creative efforts fall into the scope of protection defined by the present disclosure.

Embodiments of the present disclosure provide a method for displaying a document, which can be applied to an electronic device capable of reading the document, where the electronic device can be a terminal with a flexible display screen, such as a folding screen mobile phone, a folding screen tablet and the like. Exemplarily, this method can be applied to a terminal with a flexible display screen.

Further, an execution subject of the method for displaying a document according to the embodiments of the present disclosure can be document processing software, also called a document processing application, running in an electronic device. For example, the document processing application can be, but not limited to a WPS application such as a WPS Android application. The WPS application can be the office software of Kingsoft Office, whereas the WPS Android application is an application applied in Android devices.

Moreover, the document processing application, such as a WPS application, mainly includes three components including, for example, a document kernel, an editor, and a shell, where the three components are independent, each of the three components is composed of codes and containers. The document kernel, which is a core program of the application, can ensure the normal operation of the application; the editor is an editing component of the document, in which an editing status and a content of a document can be saved in the editor; and the shell includes functional elements such as a title bar, a menu bar and a bottom panel. Each WPS document contains the document kernel, the editor, and the shell.

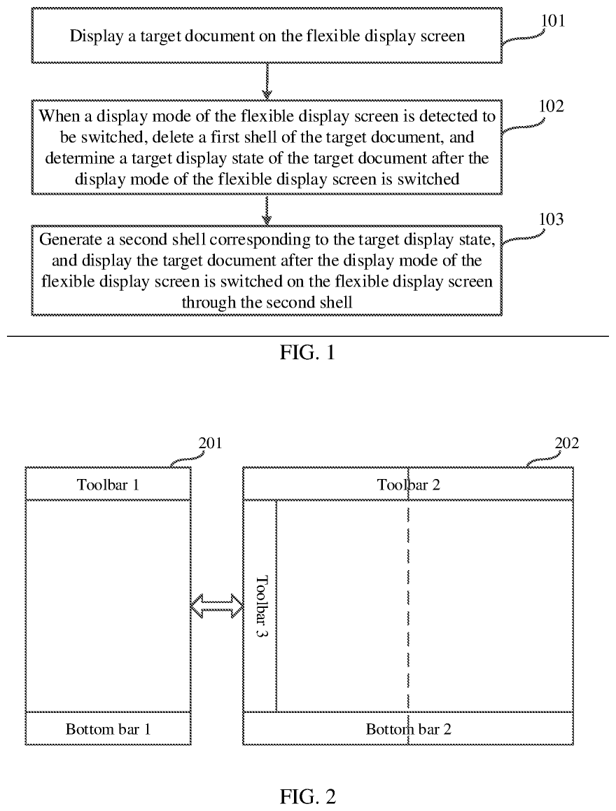

A method for displaying a document according to the embodiments of the present disclosure will be described in detail below in combination with the embodiments, as shown in FIG. 1, and steps are as follows.

At step 101, displaying a target document on a flexible display screen.

In the embodiments of the present disclosure, an electronic device can display the target document on the flexible display screen. The flexible display screen is a display component of the electronic device. The flexible display screen can be folded, unfolded, or bent based on its characteristics; correspondingly, display modes of the flexible display screen can include two display modes such as unfolding mode and folding mode or three display modes such as unfolding mode, folding mode and bending mode, and the like. When the target document is displayed on the flexible display screen, the electronic device can select a version of the target document suitable for a display size of the flexible display screen, according to the display mode of the flexible display screen. For example, if the display mode of the flexible display screen is the unfolding mode, the electronic device can display a tablet version of the target document on the flexible display screen; and if the display mode of the flexible display screen is the folding mode, the electronic device can display a mobile phone version of the target document on the flexible display screen. Exemplarily, display states of the document can include a tablet display state and a mobile phone display state. The tablet version corresponds to the tablet display state of the electronic device and the mobile phone version corresponds to the mobile phone display state of the electronic device.

The target document can be any document displayed in the document processing application. Exemplarily, when the document processing application is a WPS application, the target document can be any WPS document displayed in the WPS application.

At step 102, when a display mode of the flexible display screen is detected to be switched, a first shell of the target document is deleted, and a target display state of the target document after the display mode of the flexible display screen is switched is determined.

In the embodiments of the present disclosure, the display mode of the flexible display screen can be changed with a change of a form of the flexible display screen; when the flexible display screen is manually folded or unfolded by a user, the display mode of the flexible display screen can be changed, and the electronic device can detect the change in the display mode of the flexible display screen. When the display mode of the flexible display screen is detected to be switched, the electronic device can delete the first shell of the target document and determine the target display state of the target document after the display mode of the flexible display screen is switched. The shell can include functional elements such as a title bar, a menu bar, and a bottom panel in the target document, and the shell may be composed of codes and containers.

Optionally, deleting the first shell of the target document includes: deleting a first code and a first container included in the first shell of the target document. In the embodiments of the present disclosure, when deleting the first shell of the target document, the electronic device can delete the first code and the first container to delete the first shell of the target document. The container is configured to divide the document kernel, the editor, and the shell of the WPS Android application into three independent components, thus protecting the document kernel and the editor from being influenced by the deletion of the shell by the electronic device.

Due to the document kernel is the core program of the application, the document kernel can ensure normal operations of the application. The editor includes editing components of the document, an editing status, and a content of the document can be saved in the editor. Therefore, after the first shell is deleted, the editing status such as select, zoom and the like as well as document contents in the target document will not be lost, where the document contents include a content being processed and an unprocessed content before the display mode of the flexible display screen is switched. Optionally, determining the target display state of the target document after the display mode of the flexible display screen is switched can include step 1 and step 2:

At step 1, a target display mode of the flexible display screen is determined.

In the embodiments of the present disclosure, the electronic device can detect that the display mode of the flexible display screen is switched. When the display mode of the flexible display screen is switched, the electronic device can determine the display mode (i.e., the target display mode) of the flexible display screen after the display mode of the flexible display screen is switched according to an electrical signal triggered by switching the display mode of the flexible display screen.

At step 2, a target display state corresponding to the target display mode is determined according to a correspondence between the target display mode of the flexible display screen and the target display state of the target document.

A correspondence between respective display modes of the flexible display screen and respective display states of the document can be established in advance. In this way, when the document is displayed, the correspondence between the target display mode of the flexible display screen and the target display state of the target document can be obtained, such that the target display state corresponding to the target display mode is determined.

In the embodiments of the present disclosure, the electronic device can pre-store the correspondence between the display modes of the flexible display screen and the display states of the document, where the display modes of the flexible display screen can be changed through folding or unfolding the electronic device by a user, and the display states of the document include different versions of the document when displaying in different display modes of electronic devices. In the embodiments of the present disclosure, since the flexible display screen of the electronic device can be folded or unfolded to change the display state of the document of the electronic device, the display state of the document needs to be adapted to the different display modes of the electronic device in the embodiments of the present disclosure. After determining the switched display mode, the electronic device can determine the target display state corresponding to the target display mode according to the correspondence between the display modes of the flexible display screen and the target display states of the target document. Exemplarily, display states of the document can include a tablet display state and a mobile phone display state, the tablet display state corresponds to a document displayed on a tablet version interface, and the mobile phone display state corresponds to a document displayed on a mobile phone version interface.

At step 103, a second shell corresponding to the target display state is generated, and the target document after the display mode of the flexible display screen is switched is displayed on the flexible display screen through the second shell.

In the embodiments of the present disclosure, after the target display state corresponding to the target display mode is determined, the electronic device can generate the second shell corresponding to the target display state. After the second shell is generated, the electronic device can display the target document after the display mode of the flexible display screen is switched on the flexible display screen, where a shell in the target document after the display mode of the flexible display screen is switched is the second shell. In other words, the target document after the display mode of the flexible display screen is switched is displayed on the flexible display screen through the second shell.

FIG. 2 shows a schematic diagram of two display states of the target document corresponding to two display modes of the flexible display screen of the electronic device. An interface 201 is a display state of the target document, that is, the mobile phone display state. The interface 201 includes a toolbar 1 and a bottom bar 1. The toolbar 1 and the bottom bar 1 are functional elements included in the shell of the target document in the mobile phone display state. An interface 202 is another display state of the target document, that is, the tablet display state. The interface 202 includes a toolbar 2, a toolbar 3 and a bottom bar 2. The toolbar 2, the toolbar 3 and the bottom bar 2 are functional elements included in the shell of the target document in the tablet display state. When the flexible display screen of the electronic device is switched from the interface 201 to the interface 202, the electronic device can delete the toolbar 1 and the bottom bar 1 in the interface 201, that is, delete the functional elements included in the shell of the target document in the mobile phone display state. The toolbar 2, the toolbar 3, and the bottom bar 2 are added to a new interface, that is, the functional elements included in the shell of the target document in the tablet display state are added to form the interface 202. In other words, when the flexible display screen of the electronic device is switched from the folding mode to the unfolding mode, the electronic device can delete the toolbar 1 and the bottom bar 1 in the interface 201, and add the toolbar 2, the toolbar 3, and the bottom bar 2 to a new interface to form the interface 202.

There are a variety of implementations for generating the second shell corresponding to the target display state.

Optionally, in an implementation, generating the second shell corresponding to target display state can include step 1 and step 2.

At step 1, the second shell corresponding to the target display state is determined according to a preset correspondence between display modes and shells, where the second shell includes a second code and a second container.

In the embodiments of the present disclosure, the electronic device can determine the second shell corresponding to the target display state according to the preset correspondence between the display modes and the shells, where the second shell includes a second code and a second container. In this way, the electronic device can achieve a match between an appropriate shell and the target document in different display modes. When the target display state is determined, the shell corresponding to the target display mode is determined as the second shell corresponding to the target display state, according to the preset correspondence between the display modes and the shells.

At step 2, the second code and the second container are input into a code sequence corresponding to the target document to generate the second shell corresponding to the target display state.

In the embodiments of the present disclosure, the electronic device can input the second code and the second container into the code sequence corresponding to the target document to generate the second shell corresponding to the target display state. In the embodiments of the present disclosure, the code sequence is a code sequence of the WPS Android application. During the operations of the WPS Android application, the electronic device can delete the code of the shell and the container of the shell, and input a code of a new shell and a container of the new shell to realize a hot-reconstruction process.

Optionally, in another implementation, generating the second shell corresponding to the target display state can include:

determining the second shell corresponding to the target display state according to the preset correspondence between the display states and the shells, where the second shell includes a second code and a second container; and

inputting the second code and the second container into a code sequence corresponding to the target document to generate the second shell corresponding to the target display state.

The embodiments of the present disclosure provide a method for displaying a document, where a target document can be displayed on a flexible display screen of an electronic device. Responsive to detecting a display mode of the flexible display screen being switched, the electronic device can delete a first shell of the target document, and determine the target display state of the target document after the display mode of the flexible display screen is switched. The electronic device can generate a second shell corresponding to the target display state and display the target document after the display mode of the flexible display screen is switched on the flexible display screen through the second shell. In this way, when the display mode of the electronic device is switched, the display state of the document can be switched without closing a currently opened document and/or in-editing document. Clearly with the present solution, when switching the display state of the document, user insensitive switching is realized, and the possibility of losing content being processed before the switching is reduced, thus ensuring the safety of the document content.

Further, since there is no need to close the currently open document and/or in-editing document, the document is not required to be re-opened, thereby improving the efficiency during switching display states and improving the smoothness of document display, and improving the user experience.

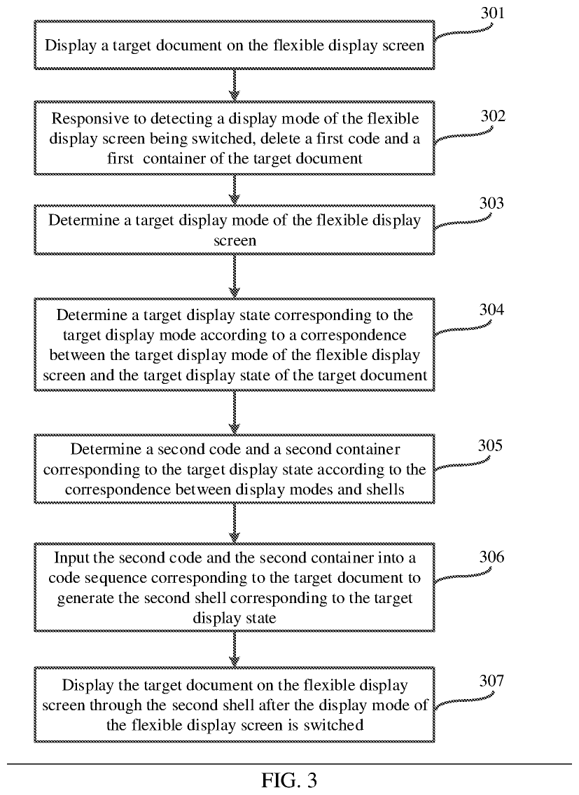

As shown in FIG. 3, an example of a method for displaying a document according to an embodiment of the present disclosure includes steps 301-307.

At step 301, a target document is displayed on the flexible display screen.

At step 302, responsive to detecting a display mode of the flexible display screen being switched, a first code and a first container are deleted.

At step 303, a target display mode of the flexible display screen is determined.

At step 304, a target display state corresponding to the target display mode is determined according to a correspondence between the target display mode of the flexible display screen and the target display state of the target document.

At step 305, a second code and a second container corresponding to the target display state are determined according to the correspondence between the display modes and the shells.

At step 306, the second code and the second container are input into a code sequence corresponding to the target document to generate the second shell corresponding to the target display state.

At step 307, the target document is displayed on the flexible display screen through the second shell after the display mode of the flexible display screen is switched.

The embodiments of the present disclosure provide a method for displaying a document, an electronic device can display a target document on the flexible display screen. Responsive to detecting the display mode of the flexible display screen being switched, the electronic device can delete a first shell of the target document, and determine the target display state of the target document after the display mode of the flexible display screen is switched. The electronic device can generate a second shell corresponding to the target display state, and display the target document after the display mode of the flexible display screen is switched on the flexible display screen through the second shell. With the embodiments of the present disclosure, the electronic device switches merely the shell of the target document while retaining the editor and the document kernel of the target document. In this way, when the electronic device switches the display state, the display state of the document can be switched without closing the currently opened document and/or in-editing document. Clearly with the present solution, when switching the display state of the document, user insensitive switching is realized, and the possibility of losing content being processed before the switching is reduced, thus ensuring the safety of the document content.

Further, since there is no need to close the currently open document and/or in-editing document, the document is not required to be re-opened, thereby improving the efficiency during switching display states and improving the smoothness of displaying the document, and improving the user experience.

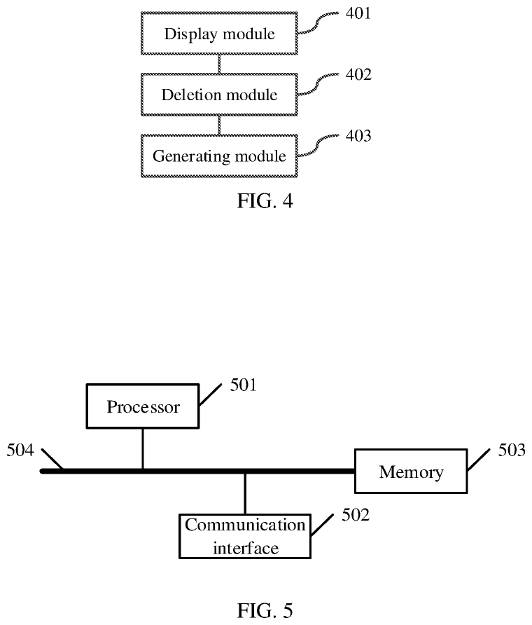

Based on the same technical construction, an embodiment of the present disclosure also provides an apparatus for displaying a document. As shown in FIG. 4, the apparatus includes:

a display module 401 configured to display a target document on the flexible display screen;

a deletion module 402 configured to, responsive to detecting a display mode of the flexible display screen being switched, delete a first shell of the target document, and determine a target display state of the target document after the display mode of the flexible display screen is switched; and

a generating module 403 configured to generate a second shell corresponding to the target display state, and display the target document after the display mode of the flexible display screen is switched on the flexible display screen through the second shell.

Optionally, the generating module 403 is configured to:

determine the second shell corresponding to the target display state according to a preset correspondence between the display modes and the shells, where the second shell includes a second code and a second container; and

input the second code and the second container into a code sequence corresponding to the target document to generate the second shell corresponding to the target display state.

Optionally, the deletion module 402 is configured to:

delete the first shell of the target document, the first shell of the target document including a first code and a first container.

Optionally, the deletion module 402 is configured to:

determine a target display mode of the flexible display screen; and

determine the target display state corresponding to the target display mode according to a correspondence between the target display mode of the flexible display screen and the target display state of the target document.

The embodiments of the present disclosure provide an apparatus for displaying a document, where an electronic device can display a target document on a flexible display screen. Responsive to detecting a display mode of the flexible display screen being switched, the electronic device can delete a first shell of the target document, and determine the target display state of the target document after the display mode of the flexible display screen is switched. The electronic device can generate a second shell corresponding to the target display state, and display the target document after the display mode of the flexible display screen is switched on the flexible display screen through the second shell. With the embodiments of the present disclosure, the electronic device switches merely the shell of the target document while retaining the editor and the document kernel of the target document. In this way, when the electronic device switches the display state, the display state of the document can be switched without closing the currently opened document and/or in-editing document. It can be seen that with the present solution, when switching the display state of the document, user insensitive switching is realized, and the possibility of losing content being processed before the switch is reduced, thus ensuring the safety of the document content.

Further, since there is no need to close the currently open document and/or in-editing document, the document is not required to be re-opened, thereby improving the efficiency during switching display states and improving the smoothness of displaying the document, and improving the user experience.

An embodiment of the present disclosure further provides an electronic device, as shown in FIG. 5, including a processor 501, a communication interface 501, a memory 503, and a communication bus 504, wherein the processor 501, the communication interface 502 and the memory 503 communicate with each other through the communication bus 504.

The memory 503 is configured to store computer programs.

The processor 501 is configured to implement the following steps when executing the programs stored on the memory 503:

displaying a target document on the flexible display screen;

responsive to detecting a display mode of the flexible display screen being switched, deleting a first shell of the target document, and determining a target display state of the target document after the display mode of the flexible display screen is switched; and

generating a second shell corresponding to the target display state; and displaying the target document after the display mode of the flexible display screen is switched on the flexible display screen through the second shell.

Exemplarily, the electronic device has a flexible display screen; exemplarily, the electronic device can be a terminal with a flexible display screen.

Optionally, generating a second shell corresponding to the target display state includes:

determining the second shell corresponding to the target display state according to a preset correspondence between display modes and shells, wherein the second shell includes a second code and a second container; and

inputting the second code and the second container into a code sequence corresponding to the target document to generate the second shell corresponding to the target display state.

Optionally, deleting the first shell of the target document includes:

deleting the first shell of the target document, the first shell of the target document including a first code and a first container.

Optionally, determining a target display state of the target document after the display mode of the flexible display screen is switched includes:

determining a target display mode of the flexible display screen; and

determining the target display state corresponding to the target display mode according to a correspondence between the target display mode of the flexible display screen and the target display state of the target document.

The communication bus in the above network device can be a Peripheral Component Interconnect (PCI) bus or an Extended Industry Standard Architecture (EISA) bus. The communication bus can be divided into an address bus, a data bus, a control bus, and the like. For ease of representation, the communication bus is only shown as one thick line in the figure, but it does not mean that there is only one bus or one type of bus.

The communication interface is used for communication between the above network device and other devices.

The memory can include a Random Access Memory (RAM), and can a Non-Volatile Memory (NVM), such as at least one disk storage. Optionally, the memory can also be at least one storage device located away from the above-mentioned processor.

The above processor can be a general-purpose processor, including a Central Processing Unit (CPU), a Network Processor (NP), etc.; or can be a Digital Signal Processing (DSP) device, an Application Specific Integrated Circuit (ASIC), a field-programmable gate array (FPGA) or other programmable logic device, a discrete gate or a transistor logic device, a discrete hardware component.

Based on the same technical concept, the present disclosure further provides a computer-readable storage medium, having computer programs stored thereon that executable by a processor, cause the processor to implement the above-mentioned steps of the method for displaying a document.

Based on the same technical concept, the present disclosure further provides a computer program product containing instructions, when executed on a computer, cause the computer to implement the above-mentioned steps of the method for displaying a document.

Based on the same technical concept, the present disclosure further provides a computer program, when executed on a computer, causes the computer to execute the above-mentioned steps of the method for displaying a document.

In the above embodiments, all or part of the implementation can be realized by software, hardware, firmware, or any combination thereof. When implemented by software, all or part of the implementation can be realized in the form of a computer program product. The computer program product includes one or more computer instructions. When the computer program instructions are loaded and executed on a computer, the procedures or functions described in accordance with the embodiments of the present disclosure will take place in whole or in part. The computer can be a general purpose computer, a special purpose computer, a computer network, or other programmable device. The computer instructions can be stored in a computer readable storage medium or transmitted from one computer readable storage medium to another computer readable storage medium, for example, the computer instructions can be transmitted from one website, computer, server, or data center to another website, computer, server, or data center via wired (e.g., coaxial cable, fiber optic, Digital Subscriber Line (DSL)) or wireless (e.g., infrared, wireless, microwave, etc.) means. The computer-readable storage medium can be any available medium that can be accessed by a computer or a data storage device, such as an integrated server, an integrated data center, etc., that includes one or more usable media. The usable media can be a magnetic media (e.g., floppy Disk, hard Disk, magnetic tape), an optical media (e.g., DVD), or a semiconductor media (e.g., Solid State Disk (SSD)), among others.

It should be noted that the relationship terms use here, such as “first,” “second,” and the like are only used to distinguish one entity or operation from another entity or operation, but do not necessarily require or imply that there is actual relationship or order between these entities or operations. Moreover, the terms “include,” “comprise,” or any variants thereof are intended to cover a non-exclusive inclusion, such that processes, methods, articles, or devices, including a series of elements, include not only those elements that have been listed, but also other elements that have not specifically been listed or the elements intrinsic to these processes, methods, articles, or devices. Without further limitations, elements limited by the wording “comprise(s) a/an . . . ” and “include(s) a/an . . . ” do not exclude additional identical elements in the processes, methods, articles, or devices, including the listed elements.

The embodiments described above are simply some embodiments of the present disclosure, and are not intended to limit the scope of protection of the present disclosure. Any modifications, alternatives, improvements, or the like within the spirit and principle of the present disclosure shall be included within the scope of protection of the present disclosure.

1. A method for displaying a document, being applied to a terminal with a flexible display screen, the method comprising:
displaying a target document on the flexible display screen;
responsive to detecting a display mode of the flexible display screen being switched, deleting a first shell of the target document, and determining a target display state of the target document after the display mode of the flexible display screen is switched; and
generating a second shell corresponding to the target display state; and displaying the target document after the display mode of the flexible display screen is switched on the flexible display screen through the second shell.

2. The method according to claim 1, wherein generating the second shell corresponding to the target display state, comprises:
determining the second shell corresponding to the target display state according to a preset correspondence between display modes and shells, wherein the second shell comprises a second code and a second container; and
inputting the second code and the second container into a code sequence corresponding to the target document to generate the second shell corresponding to the target display state.

3. The method according to claim 1, wherein deleting the first shell of the target document, comprises:
deleting a first code and a first container in the first shell of the target document.

4. The method according to claim 1, wherein determining the target display state of the target document after the display mode of the flexible display screen is switched, comprises:
determining a target display mode of the flexible display screen; and
determining the target display state corresponding to the target display mode according to a correspondence between the target display mode of the flexible display screen and the target display state of the target document.

5-8. (canceled)

9. A system comprising a processor, a communication interface, a memory, and a communication bus, wherein the processor, the communication interface and the memory communicate with each other through the communication bus;
the memory is configured to store computer programs;
the processor, when executing the computer programs stored in the memory, is configured to perform operations comprising:
displaying a target document on the flexible display screen;
responsive to detecting a display mode of the flexible display screen being switched, deleting a first shell of the target document, and determining a target display state of the target document after the display mode of the flexible display screen is switched; and
generating a second shell corresponding to the target display state; and displaying the target document after the display mode of the flexible display screen is switched on the flexible display screen through the second shell.

10. A non-transitory computer-readable storage medium, having computer programs stored thereon that executable by a processor, cause the processor to perform operations comprising:
displaying a target document on the flexible display screen;
responsive to detecting a display mode of the flexible display screen being switched, deleting a first shell of the target document, and determining a target display state of the target document after the display mode of the flexible display screen is switched; and
generating a second shell corresponding to the target display state; and displaying the target document after the display mode of the flexible display screen is switched on the flexible display screen through the second shell.

11-12. (canceled)

13. The system according to claim 9, wherein generating the second shell layer corresponding to the target display state, comprises:
determining the second shell corresponding to the target display state according to a preset correspondence between display modes and shells, wherein the second shell comprises a second code and a second container; and
inputting the second code and the second container into a code sequence corresponding to the target document to generate the second shell corresponding to the target display state.

14. The system according to claim 9, wherein deleting the first shell layer of the target document, comprises:
deleting a first code and a first container in the first shell of the target document.

15. The system according to claim 9, wherein determining the target display state of the target document after the display mode of the flexible display screen is switched, comprises:
determining a target display mode of the flexible display screen; and
determining the target display state corresponding to the target display mode according to a correspondence between the target display mode of the flexible display screen and the target display state of the target document.

16. The non-transitory computer-readable storage medium according to claim 10, wherein generating the second shell layer corresponding to the target display state, comprises:
determining the second shell corresponding to the target display state according to a preset correspondence between display modes and shells, wherein the second shell comprises a second code and a second container; and
inputting the second code and the second container into a code sequence corresponding to the target document to generate the second shell corresponding to the target display state.

17. The non-transitory computer-readable storage medium according to claim 10, wherein deleting the first shell layer of the target document, comprises:
deleting a first code and a first container in the first shell of the target document.

18. The non-transitory computer-readable storage medium according to claim 10, wherein determining the target display state of the target document after the display mode of the flexible display screen is switched, comprises:
determining a target display mode of the flexible display screen; and
determining the target display state corresponding to the target display mode according to a correspondence between the target display mode of the flexible display screen and the target display state of the target document.
